(19) United States
(12) Patent Application Publication
(10) Pub. No.: US 2011/0084825 A1
(43) Pub. Date: Apr. 14, 2011

(54) System and method for monitoring and communicating the actions of riders of group transportation

(75) Inventor: Thomas John, New Hyde Park, NY (US)

(73) Assignee: American Gardens Management Co., New Hyde Park, NY (US)

(21) Appl. No.: 12/877,333

(22) Filed: Sep. 8, 2010

Related U.S. Application Data
(60) Provisional application No. 61/240,385, filed on Sep. 8, 2009.

(51) Int. Cl. B60Q 1/00; G08B 1/08

(52) U.S. Cl. 340/438; 340/539.13

(57) ABSTRACT

In accordance with one embodiment, a system and method for monitoring and communicating the actions of riders of a group transportation vehicle includes an identifying device that is uniquely associated with and uniquely identifies one rider and a device, such as a reader, that is part of the vehicle and reads information stored on the identifying device. The vehicle includes a controller/wireless communication module that communicates wirelessly with remote devices, such as hand-held units, like cell phone and PDAs and personal computers, etc. The controller communicates with a GPS module and therefore the system keeps track of passengers as they enter and exit the vehicle as a means to ensure that all passengers have exited the vehicle at the end of the route before the vehicle is stored for the night, etc. In addition, the system provides an effective alert system that allows a third party, such as a parent, to receive communication, such as a message, that the child or adult of interest the passenger) has left the point of origin and an estimated time of arrival for the passenger at the specific drop off location.

### CROSS-REFERENCE TO RELATED APPLICATION

The present application claims the benefit of U.S. patent application Ser. No. 61/240,385, filed Sep. 8, 2009, which is hereby incorporated by reference.

### TECHNICAL FIELD

The present invention relates to monitoring systems and in particular, the present invention relates to a system for monitoring the actions of riders of group transportation, such as a bus, including wirelessly sending messages and alerts when prescribed events occur.

### BACKGROUND

Ground transportation can come in any number of different forms and include vehicles, buses, trains, etc. In certain settings, it is very important to monitor the actions of occupants or riders of ground transportation. In addition, the actions of certain individuals need to be monitored more closely than others. For example, the actions of young children, special needs students, and handicapped individuals and students need to be more closely monitored due to their age and/or conditions when they board, travel and exit the ground transportation, typically a bus.

Unfortunately, ground transportation is not particularly well adept at caring and monitoring such individuals. In particular, periodically, there are heartbreaking stories of a handicapped person or student being left on a bus for countless hours after the bus route has been completed and the bus driver unfortunately has made a mistake and overlooked the presence of the individual. In addition, parents nervously hope that their young children board the proper ground transportation and exit at the appropriate location. Unfortunately, due to their age, sometimes, children forget or otherwise become preoccupied and do not properly exit the bus at the proper location or board the wrong bus to begin with. While the driver of the bus may catch such events, one cannot rely on the actions of the bus driver and further, there may be a substitute driver who is not aware of each child's itinerary.

Thus, there is a need for providing an alternative system for monitoring the actions of occupants on group transportation, such as a bus.

### SUMMARY

In accordance with one embodiment, a system and method for monitoring and communicating the actions of riders of a group transportation vehicle includes an identifying device that is uniquely associated with and uniquely identifies one rider and a device, such as a reader, that is part of the vehicle and reads information stored on the identifying device. The vehicle includes a controller/wireless communication module that communicates wirelessly with remote devices, such as hand-held units, like cell phone and PDAs and personal computers, etc. The controller communicates with a GPS module and therefore the system keeps track of passengers as they enter and exit the vehicle as a means to ensure that all passengers have exited the vehicle at the end of the route before the vehicle is stored for the night, etc. In addition, the system provides an effective alert system that allows a third party, such as a parent, to receive communication, such as a message, that the child or adult of interest (the passenger) has left the point of origin and an estimated time of arrival for the passenger at the specific drop off location.

These and other aspects, features and advantages shall be apparent from the accompanying Drawings and description of certain embodiments of the invention.

### BRIEF DESCRIPTION OF THE DRAWINGS

FIG. 1 is a schematic view of a school bus that incorporates the monitoring system of the present invention; and

FIG. 2 is a schematic showing the various components of the present invention.

### DETAILED DESCRIPTION OF CERTAIN EMBODIMENTS OF THE INVENTION

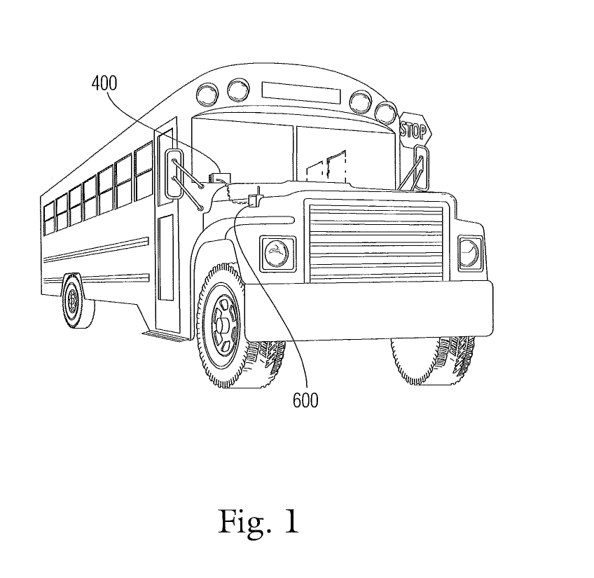

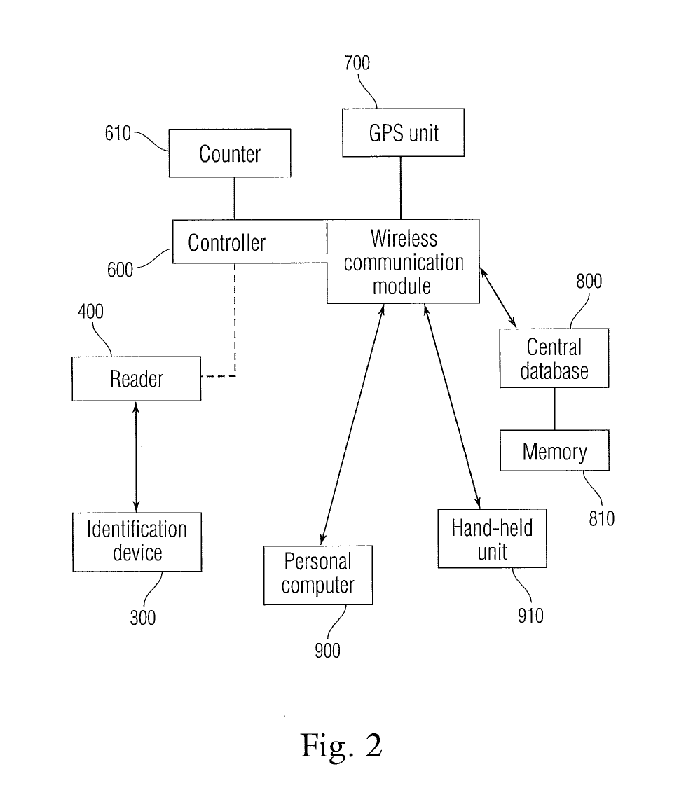

In accordance with one embodiment of the present invention, a monitoring system 200 for monitoring and communicating the actions of riders of group transportation 100 is provided and is illustrated in FIG. 1-2. FIG. 1 illustrates one exemplary form of group transportation 100 in the form of a school bus; however, it will be appreciated the group transportation 100 can assume any number of other forms, including but not limited to mass transit buses, vans, etc. As is known, a school bus or van 100 includes a central door 110 through which passengers enter and exit. Regardless of whether the bus or van 100 is being used in a school ground setting or for the transportation of children or adults from one location to another, the passenger has an itinerary in that the passenger enters the bus or van 100 at one location and then subsequently exits the bus 100 at another location. Buses 100 can carry a significant number of passengers and therefore it can become difficult to keep track all of the passengers. For example, in many school bus settings, it is up to the child (passenger) to stand up or otherwise alert the driver that this particular passenger is present and wishes to exit the bus at what should be their customary exit location. While the bus driver might slow down near a known stop, it is generally up to the passenger to alert the driver that a stop is desired or else the driver has to go by memory and recall which passengers entered the bus. Unfortunately, children can become preoccupied or otherwise not be able to alert the driver that a stop is desired (e.g., child falls asleep). Also, those children or adults with special needs may simply not be capable of alerting the driver.

As described in detail herein, the monitoring system 200 of the present invention has particular utility for use with vehicles that transport young children, special needs children or adults and/or children or adults that have some impairment or handicap.

The system 200 is shown in more detail in FIG. 2. The passenger monitoring system 200 includes an identification device 300 that is worn or otherwise carried or associated with a specific passenger. The identification device 300 contains information that uniquely identifies the individual who is wearing or otherwise has possession of the device 300.

The identification device 300 can take any number of different forms including but not limited to an RFID tag or chip, a bar code member, or any other structure that is capable of storing identification information and transmitting it to a reader or the like. Several exemplary identifications devices 300 include an RFID tag or bracelet 300 or a bracelet 300 that has a bar code incorporated therein. Instead of a bracelet, the RFID tag or chip or the bar code can be part of a button or the like. The identification device 300 should not be easily removable from the person.

The identification device 300 stores some basic identifying information concerning the passenger that serves to uniquely identify the passenger. For example, the identification device 300 can store the name of the passenger, the birth date and age of the passenger, the home address of the passenger, social security number, emergency contact information, etc. In addition, the identifying information can include additional information that is more specific to the ground transportation (bus 100). In particular, the identifying information can include the normal bus number or bus route number which the passenger takes in order to complete the trip and end up at a desired drop off location, such as the residence of the passenger.

The identifying information can also include the start point or origin of the trip and a drop off location at which the passenger is to be dropped off. As described below, this will allow a close monitoring of the passenger to ensure that the passenger not only has boarded the proper bus but also has exited at the proper location.

FIG. 2 shows a schematic of the system 200. In addition, to the identification device 300, the system 200 includes a reader 400 that reads the identification information/data that is contained on the identification device 300. For example, when the identification device 300 is in the form of an RFID tag, the reader 400 can be an RFID receiver and when the identification device 300 is in the form of member with a bar code, the reader 400 is in the form of a bar code scanner. It will be appreciated that other types of readers can be used so long as they are capable of reading the identification information and then can transmit the information to another device.

As shown in FIG. 1, the reader 400 will be located at or proximate the door 110 of the bus or van 100 so that each time a passenger boards or exits the bus/van 100, the reader 100 detects and reads the information contained on the identification device 300. The reader 400 will therefore read the identification information when the passenger boards and then again reads the information when the passenger exits.

The system 200 also includes a controller 600 that has a wireless communication module that permits information to be communicated wirelessly from the controller 600 to another remote device, such as a server, over a network, such as the internet. The controller 600 and wireless module are also located on board the bus/van 100 and are in communication (wired or wireless) with the reader 400 to receive the information that is read by reader 400.

In accordance with one aspect of the present invention, the controller 600 includes a counter 610 that records and keeps track of the total number of passengers that enter the bus 100 for a given route or run and likewise the total number of passengers that exit the bus 100 for the same route or run. For example, the driver of the bus 100 can instruct the controller 600 through an input device (such as an on-board display or on-board computer, etc.) that a particular route or run is about to begin (prior to any passengers entering) (e.g., this can be done in the school ground while waiting for the students). As each passenger enters the bus 100 and there presence is detected by reader 400, the counter 610 is incremented by 1. Similarly, as each passenger exits the bus and is detected by reader 400, the counter 610 decreases by 1.

Software controlling the operation of counter 610 is capable of knowing whether a passenger has entered or not before and therefore, when a passenger is detected by reader 400, the controller 600 first searches a database to see if this uniquely identifiable passenger has been entered into the database already, thus indicating a prior entrance onto the bus, and if so, the controller 600 then counts this second detection of the passenger as an exit from the bus 100. Similarly, if there is no record or entry of this passenger in the database, then the detection is counted as an entrance into the bus 100.

The counter 610 is part of the monitoring system in that once the route is completed, the counter 610 should read zero in that each passenger that entered and subsequently exited. If the counter 610 does not read zero, the driver must investigate the bus with at utmost level of care to make sure that a passenger is not left unaccounted for and is somewhere present on the bus.

The system 200 also includes an on-board GPS system that includes a GPS unit (receiver) 700 that is located within the vehicle 100. The GPS unit 700 is in communication with a GPS satellite that serves, as is know, to track the movements of the vehicle 100 (GPS provides reliable positioning, navigation, and timing services to worldwide users on a continuous basis in all weather, day and night, anywhere on or near the Earth).

The GPS unit 700 communicates with the controller 600 to allow positioning data to be captured and stored in the local memory. For example, each time a passengers enters the vehicle 100, the date, time, and starting location for the ride for this particular passenger is captured and stored in memory associated with controller 600. Since each passenger has a unique identifier, the GPS data can be uniquely associated with this passenger and can be stored under their profile, etc. Also, when the trip is completed and the passenger exists, the positioning data and time and date data are captured. In other words, an information portfolio is built for each passenger that includes not only the identification information of the passenger but also the date and time and location of where the passenger entered (start point of the trip) and the date and time and location of where the passenger exited (end point of the trip).

While all this information including the image of each customer can be stored locally at controller/module 600, the controller 600 includes a wireless communications module and therefore can wirelessly send and receive data from other remote devices. In particular, the controller 600 communicates with a central database 800 that includes memory 810. In this manner, all of the passenger information (identification information and GPS data) is also stored remotely in memory 710.

The controller 600 can also be in communication (e.g., wireless) with a number of other devices, that are connected via a network (internet) such as a personal computer 900 and/or a hand-held communication device 910, such as a cell phone or PDA.

It will also be appreciated that the system 200 can include a number of warning or alert systems to alert the driver that a prescribed event has occurred that requires investigation by the driver. For example, if the passenger exits at a location (detectable via the GPS unit 700) that does not match and is not within a tolerance range of the position coordinates of the exit location stored in the identification device 300, then an audible and/or visual warning can be generated. Along these lines, a display unit can be mounted within the bus in view of the driver for displaying messages or other information. This alarm or alert can be sounded and/or displayed as soon as the reader detects the passenger exiting the bus 100 and thus, remedial action can be taken such as asking the passenger if this is the correct stop for them and/or further investigating the matter.

The controller 600 can also be configured so that once the route begins, a message can be sent to a third party, such as a parent, to alert the third party that the route has begun and further provide the third party with ETA (estimated time of arrival) for the passenger that is associated with the third party. For example, a parent or guardian or other interested party can receive an alert (e.g., text message, email, etc.) that first indicates that the individual of interest (e.g., a child or loved on that is wearing the identification device) has entered the bus, van 100 and since movement of the bus can be detected by the GPS system, the message can indicate when the bus, van 100 began its route. Moreover, since the identification information stored on the identifying device worn by the passenger includes the normal exit location for the person, the message can list an estimate time of arrival for this particular passenger. This will allow a parent or loved one to better gauge “when the bus may show up” with their child. Many parents wait outside adjacent the road for the arrival of the child and therefore, this system 200 provides very specific, reliable data that assists the parent in deciding when to go outside and wait. No more waiting an excess amount of time for a delayed or late bus arrival.

The system 200 can also be configured such that if an unexpected delay is encountered and the new estimated time of arrival, as calculated by the GPA unit, exceeds some threshold, such as 5 minutes, a second message can be sent alerting the third party of the delay and provide them with the new estimated time of arrival.

The information that is associated with the passenger portfolio can also include a photo or image of the passenger that can be displayed on the on-board display. For example, when the identification device xxx is read, the image of the passenger can be displayed to permit visual confirmation.

In the event that the passenger does not have an identification member, some means of identification, such as the name of the passenger, can be provided to the driver who can then search the database for the passenger. Upon located the passenger in the database, a temporary identification device, such as a paper bracelet that includes a bar code or the like can be printed on-board and then worn by the passenger. This entire process can be completed very quickly and allows the monitoring of the passenger in the same way described above in the case of the permanent identification member, such a bracelet or tag, etc.

The present invention thus provides a monitoring system that not only keeps track of passengers as they enter and exit a group transportation vehicle, such as a bus, as a means to ensure that all passengers have exited the vehicle at the end of the route before the vehicle is stored for the night, etc. In addition, the system provides an effective alert system that allows a third party, such as a parent, to receive communication, such as a message, that the child or adult of interest (the passenger) has left the point of origin and an estimated time of arrival for the passenger at the specific drop off location (e.g., school bus stop near the passenger's home) is provided. Other safety measures are described herein.

While the invention has been described in connection with certain embodiments thereof, the invention is capable of being practiced in other forms and using other materials and structures. Accordingly, the invention is defined by the recitations in the claims appended hereto and equivalents thereof.

What is claimed is:

1. A system and method for monitoring and communicating the actions of riders of a group transportation vehicle comprising:
an identification device that is associated with and uniquely defines one specific rider;
a reader that is configured to read information stored on the identification device, the reader being proximate an entrance to the vehicle;
a controller that is in wireless communication with a remote device, wherein the controller is associated with the vehicle, the controller includes a counter that detects when each rider enters and exits the vehicle and stores a value of the total number of riders that are in the vehicle at any one time, wherein at any time, the controller is configured to know the identities of the riders currently in the vehicle; and
a global positioning system (GPS) associated with the vehicle for detecting a location of the vehicle, wherein the controller is configured to store location data relating to location where each rider enters and exits the vehicle;
wherein the controller is configured to generate an alert when a prescribed event occurs, wherein the prescribed event is selected from the group consisting of: the counter displays a positive value after the vehicle has completed a route and a rider exits at a different location than an exit location that is part of the information stored on the identification device.
